(19) United States
(12) Patent Application Publication
(10) Pub. No.: US 2022/0410674 A1
(43) Pub. Date: Dec. 29, 2022

(54) VEHICLE SIDE STRUCTURE

(71) Applicants: Toyota Jidosha Kabushiki Kaisha, Toyota-shi Aichi-ken (JP); Aisin Corporation, Kariya Aichi (JP)

(72) Inventors: Hideaki Kanasugi, Nisshin-shi Aichi-ken (JP); Dai Hidaka, Kariya-shi Aichi-ken (JP); Taiki Ishiguro, Kariya-shi Aichi-ken (JP)

(73) Assignees: Toyota Jidosha Kabushiki Kaisha, Toyota-shi Aichi-ken (JP); Aisin Corporation, Kariya Aichi (JP)

(21) Appl. No.: 17/846,096

(22) Filed: Jun. 22, 2022

(30) Foreign Application Priority Data
Jun. 28, 2021 (JP) 2021-107062

(51) Int. Cl. B60J 5/06; B60J 5/04; B60P 1/43

(52) U.S. Cl. CPC B60J 5/06; B60J 5/0479; B60J 5/0497; B60P 1/431

(57) ABSTRACT

A vehicle side structure includes: a vehicle body side structure including a boarding opening through which an occupant gets into and out of a vehicle; a sliding door configured to slide to open and close the boarding opening; an upper support structure; a middle support structure; a lower support structure; and a drive unit located in an upper portion of the vehicle body side structure and configured to drive the sliding door to open and close via at least a part of the upper support structure. The upper support structure, the middle support structure, and the lower support structure are configured to support the sliding door in upper, middle, and lower portions of the vehicle body side structure in a vertical direction of a vehicle such that the sliding door slides, respectively.

### CROSS-REFERENCE TO RELATED APPLICATION

This application claims priority to Japanese Patent Application No. 2021-107062 filed on Jun. 28, 2021, incorporated herein by reference in its entirety.

### BACKGROUND

### 1. Technical Field

The present disclosure relates to vehicle side structures, and particularly to a side structure of a vehicle with a sliding door.

### 2. Description of Related Art

So-called sliding doors that slide along the side of a vehicle to open and close are known as doors that open and close a boarding opening through which an occupant gets into and out of the vehicle. The sliding door is supported by, for example, a hinge that is guided by a rail placed on a vehicle body. The sliding door also slides as the hinge slides along the rail. For vehicles having a great overall height and a great sliding door height, sliding doors that are supported at three positions, namely in the upper, lower, and middle portions of the vehicle body, are known.

Japanese Unexamined Patent Application Publication No. 2003-320852 (JP 2003-320852 A) shows in FIGS. 1 to 4, a structure in which arms 22 to 25 rotatably coupled to a cab 1 support a sliding door 11 via a slide rail 26 fixed to the sliding door 11. The above signs are the signs used in JP 2003-320852 A, and are not related to the signs used in the description of an embodiment of the present application.

### SUMMARY

In order to lower the floor of a vehicle, it is necessary to reduce space occupied by parts and devices placed under the floor. Placing a drive unit for opening and closing a sliding door under the floor hinders lowering of the floor. For example, in a vehicle that stores a wheelchair ramp under the floor, other parts such as a drive unit for a sliding door are required to be placed somewhere other than under the floor in order to secure enough space for the wheelchair ramp under the floor.

A vehicle side structure according to a first aspect of the present disclosure includes: a vehicle body side structure including a boarding opening through which an occupant gets into and out of a vehicle; a sliding door configured to slide to open and close the boarding opening; an upper support structure configured to support the sliding door in an upper portion of the vehicle body side structure in a vertical direction of the vehicle such that the sliding door slides; a middle support structure configured to support the sliding door in a middle portion of the vehicle body side structure in the vertical direction of the vehicle such that the sliding door slides; a lower support structure configured to support the sliding door in a lower portion of the vehicle body side structure in the vertical direction of the vehicle such that the sliding door slides; and a drive unit located in the upper portion of the vehicle body side structure and configured to drive the sliding door to open and close via at least a part of the upper support structure.

Since the drive unit configured to drive the sliding door to open and close is located in the upper portion of the vehicle body side structure, space occupied by parts and devices that are mounted under the floor can be reduced.

The upper support structure may be located above an upper edge of the boarding opening in the vertical direction of the vehicle, and the drive unit may be located inward of the upper support structure in a lateral direction of the vehicle along the upper support structure. The upper edge of the boarding opening is located at a position higher than the height of a typical occupant. Placing the drive unit as described above can therefore suppress a decrease in substantial space for occupants.

The sliding door may be configured to be supported in the vertical direction of the vehicle by at least one of the upper support structure or the middle support structure. Since parts for supporting the sliding door in the vertical direction of the vehicle are provided in a support structure other than the lower support structure, space occupied by parts that are mounted under the floor can be reduced.

The upper support structure may include an upper rail and an upper hinge, the upper rail being located on the vehicle body side structure along the upper edge of the boarding opening, and the upper hinge being configured to slide with the sliding door and be guided by the upper rail. The middle support structure may include a center rail and a center hinge, the center rail being located on the vehicle body side structure and extending from a side edge of the boarding opening in a direction away from the boarding opening, and the center hinge being configured to slide with the sliding door and be guided by the center rail. The lower support structure may include a lower rail and a lower hinge, the lower rail being located on the sliding door at a position lower than the center hinge in the vertical direction of the vehicle and extending in a direction along a lower edge of the sliding door in the vertical direction of the vehicle, and the lower hinge being located on the vehicle body side structure near the side edge of the boarding opening and configured to guide the lower rail when the sliding door slides. The drive unit may be configured to drive the upper hinge along the upper rail to drive the sliding door to open and close.

The drive unit may include a belt extending along the upper rail, and a motor configured to drive the belt, and the upper hinge may include a coupling portion configured to be coupled to the belt.

The upper rail may include an upper guide rail portion that includes a pair of upper vertical walls extending in the vertical direction of the vehicle, the upper hinge may include an upper guide roller located in such a manner that a rotation axis of the upper guide roller matches the vertical direction of the vehicle, and the upper guide roller may be located between the upper vertical walls. The center rail may include a center guide rail portion that includes a pair of center vertical walls extending in the vertical direction of the vehicle, the center hinge may include a center guide roller located in such a manner that a rotation axis of the center guide roller matches the vertical direction of the vehicle, and the center guide roller may be located between the center vertical walls. The lower rail may include a lower guide rail portion that includes a pair of lower vertical walls extending in the vertical direction of the vehicle, the lower hinge may include a lower guide roller located in such a manner that a rotation axis of the lower guide roller matches the vertical direction of the vehicle, and the lower guide roller may be located between the lower vertical walls.

The upper rail may include an upper support rail portion, and the upper hinge may include an upper support roller located on an upper surface of the upper support rail portion such that a rotation axis of the upper support roller is horizontal.

The center rail may include a center support rail portion, and the center hinge may include a center support roller located on an upper surface of the center support rail portion such that a rotation axis of the center support roller is horizontal.

The vehicle body side structure may further include a ramp opening located below a lower edge of the boarding opening in the vertical direction of the vehicle, and configured to allow a wheelchair ramp to pass through the ramp opening when the wheelchair ramp stored under a floor of the vehicle is deployed and retracted.

The sliding door may include a first sliding door and a second sliding door, and the sliding door may be a double door provided by the first sliding door and the second sliding door.

Since the drive unit that drives the sliding door to open and close is placed in the upper portion of the vehicle body side structure, the space occupied by parts and devices that are mounted under the floor can be reduced. This contributes to lowering of the floor.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows the appearance of a vehicle according to an embodiment;

FIG. 2 is a perspective view schematically showing a side structure, particularly a left side structure, of the vehicle;

FIG. 3 is a sectional view showing a structure around a lower edge of a boarding opening;

FIG. 4 schematically shows rails and hinges that are located in upper, middle, and lower portions of the vehicle;

FIG. 5 shows a drive unit and an upper support structure;

FIG. 6 shows the upper support structure, particularly details of an upper rail and rollers;

FIG. 7 shows the upper support structure, particularly details of the rollers;

FIG. 8 shows a middle support structure;

FIG. 9 shows the middle support structure, particularly details of a center rail and rollers; and

FIG. 10 shows a lower support structure.

### DETAILED DESCRIPTION OF EMBODIMENTS

Hereinafter, an embodiment of the present disclosure will be described with reference to the drawings. In the following description, the terms indicating relative positions and directions such as front, rear, right, left, up, and down indicate the relative positions and directions with respect to a vehicle, unless otherwise specified. The “inner side in the lateral direction of the vehicle” or “inward in the lateral direction of the vehicle” refers to the side in the right-left direction (lateral direction) of the vehicle that is closer to the centerline extending in the front-rear direction (longitudinal direction) of the vehicle, and the “outer side in the lateral direction of the vehicle” or “outward in the lateral direction of the vehicle” refers to the side in the lateral direction of the vehicle that is farther from the centerline extending in the longitudinal direction of the vehicle. In each figure, the direction of arrow FR indicates a forward direction, the direction of arrow UP indicates an upward direction, the direction of arrow LH indicates a leftward direction, and the direction of arrow OUT indicates the outer side in the lateral direction of the vehicle.

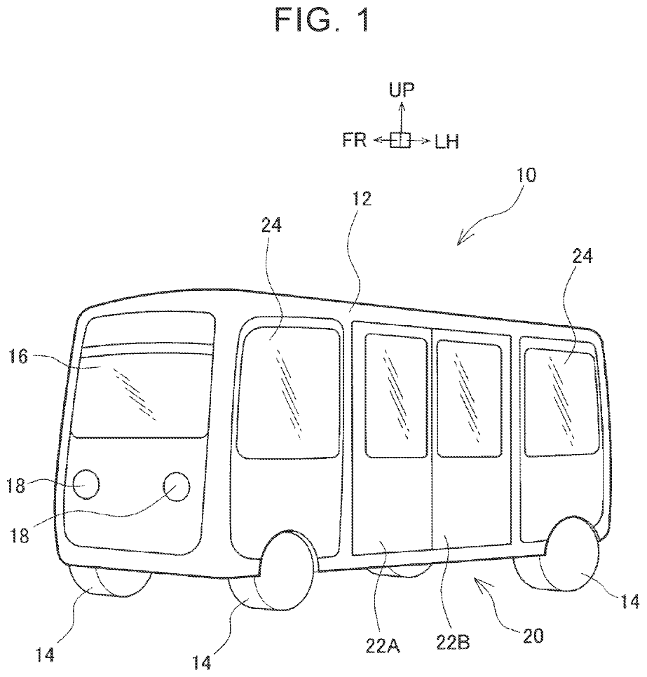

FIG. 1 is a perspective view schematically showing the appearance of a vehicle 10. The vehicle 10 includes a vehicle body 12 substantially in the shape of a rectangular parallelepiped. The vehicle body 12 has the longest dimension in the longitudinal direction, followed by in the vertical direction. Wheels 14 are located at the four corners of the vehicle body 12. A windshield glass 16 is located in an upper region of the front face of the vehicle body 12, and headlamps 18 are mounted on the right and left sides of a lower region of the front face of the vehicle body 12. A back window glass (not shown) having the same shape as the front windshield glass 16 is located on the rear face of the vehicle body 12, and rear combination lamps (not shown) are mounted on the rear face of the vehicle body 12 at the same positions as the headlamps 18 on the front face of the vehicle body 12.

A door 20 for boarding is located on a side of the vehicle body 12. The door 20 is located on one side of the vehicle body 12. Specifically, the door 20 is located on the left side of the vehicle body 12 in areas where vehicles drive on the left side of the road, and is located on the right side of the vehicle body 12 in areas where vehicles drive on the right side of the road. The door 20 may be located on both sides of the vehicle body 12. The door 20 includes two sliding doors 22A, 22B that slide in the longitudinal direction of the vehicle 10. The door 20 opens and closes as the sliding doors 22A, 22B slide. When the sliding doors 22A, 22B open, the sliding doors 22A, 22B first move outward in the lateral direction of the vehicle 10 while sliding from the closed state, and then slide outside the vehicle body 12 along the side of the vehicle body 12. The sliding doors 22A, 22B are provided with door glasses that form door windows. The door 20 is located substantially in the middle of the side of the vehicle body 12 in the longitudinal direction of the vehicle 10, and side window glasses 24 are located forward and rearward of the door 20 and form side windows. A side window is located on the side of the vehicle body 12 where the door 20 is not located. The side window extends along the entire length in the longitudinal direction of the vehicle body 12.

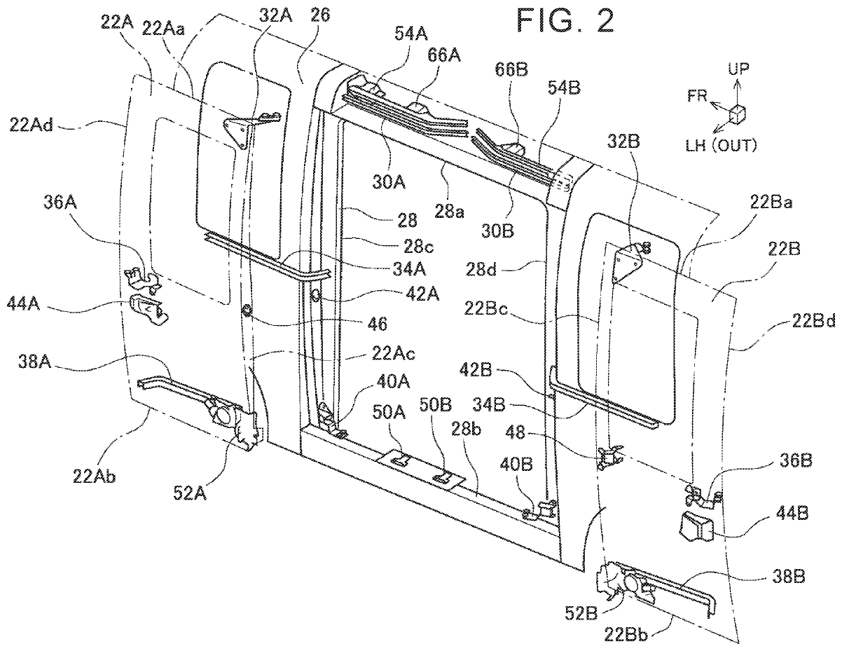

FIG. 2 schematically shows a structure of a side portion of the vehicle 10, particularly a side portion related to an entrance and exit. FIG. 2 shows a vehicle side structure on the left side of the vehicle 10, particularly with a vehicle body side structure 26 of the vehicle body 12 and the sliding doors 22A, 22B being shown separated from each other. In the case where the door is located on the right side of the vehicle, a vehicle side structure on the right side of the vehicle is symmetrical with the vehicle side structure on the left side of the vehicle shown in the figure. The vehicle body side structure 26 has a boarding opening 28 through which an occupant etc. gets into and out of the vehicle 10. The sliding doors 22A, 22B open and close the boarding opening 28. In FIG. 2, the sliding doors 22A, 22B are shown in phantom.

The boarding opening 28 is substantially rectangular and has an upper edge 28a, a lower edge 28b, a front side edge 28c, and a rear side edge 28d. The upper edge 28a and the lower edge 28b extend in the longitudinal direction of the vehicle 10, and the front side edge 28c and the rear side edge 28d extend in the vertical direction.

The sliding doors 22A, 22B are substantially in the shape of a rectangular parallelepiped, and each sliding door 22A, 22B has such a size that the sliding door 22A, 22B covers about half of the boarding opening 28. Upper edges of the two sliding doors 22A, 22B are denoted by 22Aa, 22Ba, and lower edges of the two sliding doors 22A, 22B are denoted by 22Ab, 22Bb. Edges of the two sliding doors 22A, 22B that come into contact with each other when the sliding doors 22A, 22B are closed, that is, edges of the two sliding doors 22A, 22B that define the entrance and exit when the door 20 is opened, are referred to as tip edges 22Ac, 22Bc, and the opposite edges of the two sliding doors 22A, 22B from the tip edges 22Ac, 22Bc are referred to as base edges 22Ad, 22Bd. The upper edges 22Aa, 22Ba and lower edges 22Ab, 22Bb of the sliding doors 22A, 22B correspond to the upper edge 28a and lower edge 28b of the boarding opening 28, and extend in the longitudinal direction of the vehicle 10. The tip edge 22Ac of the sliding door 22A and the tip edge 22Bc of the sliding door 22B face each other in the longitudinal direction of the vehicle 10 and extend in the vertical direction. The base edge 22Ad of the sliding door 22A extends along, and is located adjacent to, the front side edge 28c of the boarding opening 28 when the sliding door 22A is closed. The base edge 22Bd of the sliding door 22B extends along, and is located adjacent to, the rear side edge 28d of the boarding opening 28 when the sliding door 22B is closed.

Each of the sliding doors 22A, 22B is supported on the vehicle body side structure 26 at three positions of the vehicle 10, namely in the upper, lower, and middle portions of the vehicle 10, particularly in the upper, lower, and middle portions of the vehicle side structure, by an upper support structure, a lower support structure, and a middle support structure. The middle portion of the vehicle 10 or the vehicle side structure refers to a portion between the upper and lower portions of the vehicle 10 or the vehicle side structure. The upper support structure, the lower support structure, and the middle support structure slidably support each sliding door 22A, 22B by rails and hinges. The rails extend in the longitudinal direction of the vehicle 10, and the hinges slide relatively to the rails. The sliding doors 22A, 22B are guided by these rails to slide.

Upper rails 30A, 30B are placed along and near the upper edge 28a of the boarding opening 28 on the vehicle body side structure 26. The upper rail 30A corresponds to the sliding door 22A, and the upper rail 30B corresponds to the sliding door 22B. Hereinafter, the elements corresponding to the sliding door 22A are denoted by the signs with the letter “A” at the end, and the elements corresponding to the sliding door 22B are denoted by the signs with the letter “B” at the end. Upper hinges 32A, 32B are placed at the corners formed by the upper edges 22Aa, 22Ba and tip edges 22Ac, 22Bc of the sliding doors 22A, 22B. The upper hinges 32A, 32B slidably engage with the corresponding upper rails 30A, 30B. When the sliding doors 22A, 22B slide, the upper hinges 32A, 32B also slide with the sliding doors 22A, 22B. The upper rail 30A and the upper hinge 32A form an upper support structure that supports the sliding door 22A in the upper portion of the vehicle body side structure 26, and the upper rail 30B and the upper hinge 32B form an upper support structure that supports the sliding door 22B in the upper portion of the vehicle body side structure 26. These upper support structures are mounted at a position above the upper edge 28a of the boarding opening 28, that is, at a position higher than the upper edge 28a of the boarding opening 28.

Center rails 34A, 34B are placed on the vehicle body side structure 26. The center rails 34A, 34B extend from the front side edge 28c and rear side edge 28d of the boarding opening 28 in a direction away from the boarding opening 28. The center rails 34A, 34B are located at a position lower than the upper rails 30A, 30B. For example, the center rails 34A, 34B are located substantially at the middle height of the boarding opening 28. Center hinges 36A, 36B are placed near the base edges 22Ad, 22Bd of the sliding doors 22A, 22B at the height corresponding to the height at which the center rails 34A, 34B are located. The center hinges 36A, 36B slidably engage with the corresponding center rails 34A, 34B. When the sliding doors 22A, 22B slide, the center hinges 36A, 36B also slide with the sliding doors 22A, 22B. The center rail 34A and the center hinge 36A form a middle support structure that supports the sliding door 22A in the middle portion of the vehicle body side structure 26, and the center rail 34B and the center hinge 36B form a middle support structure that supports the sliding door 22B in the middle portion of the vehicle body side structure 26.

Lower rails 38A, 38B are placed on the sliding doors 22A, 22B at a position lower than the center hinges 36A, 36B, such as near the lower edges 22Ab, 22Bb of the sliding doors 22A, 22B, along the lower edges 22Ab, 22Bb. A lower hinge 40A is placed on the front side edge 28c of the boarding opening 28 at the height corresponding to the height at which the lower rail 38A is located. The lower hinge 40A relatively slidably engages with the lower rail 38A. A lower hinge 40B is placed on the rear side edge 28d of the boarding opening 28 at the height corresponding to the height at which the lower rail 38B is located. The lower hinge 40B relatively slidably engages with the lower rail 38B. When the sliding doors 22A, 22B slide, the lower rails 38A, 38B also slide with the sliding doors 22A, 22B. The lower rail 38A and the lower hinge 40A form a lower support structure that supports the sliding door 22A in the lower portion of the vehicle body side structure 26, and the lower rail 38B and the lower hinge 40B form a lower support structure that supports the sliding door 22B in the lower portion of the vehicle body side structure 26.

A front side edge striker 42A is placed in the middle portion in the vertical direction of the front side edge 28c of the boarding opening 28. A base edge lock unit 44A corresponding to the front side edge striker 42A is placed near the base edge 22Ad of the sliding door 22A. Similarly, a rear side edge striker 42B is placed in the middle portion in the vertical direction of the rear side edge 28d of the boarding opening 28. A base edge lock unit 44B corresponding to the rear side edge striker 42B is placed near the base edge 22Bd of the sliding door 22B. Each of the base edge lock units 44A, 44B includes a hook (not shown) that catches a rod-like portion of the corresponding side edge striker 42A, 42B. When the sliding doors 22A, 22B are closed, the hooks of the base edge lock units 44A, 44B engage with the corresponding side edge strikers 42A, 42B. The sliding doors 22A, 22B are thus fixed to the vehicle body 12 at the base edges 22Ad, 22Bd.

A tip edge striker 46 is placed in the middle portion in the vertical direction of the tip edge 22Ac of the sliding door 22A. A tip edge lock unit 48 corresponding to the tip edge striker 46 is placed near the tip edge 22Bc of the sliding door 22B. The tip edge lock unit 48 includes a hook (not shown) that catches a rod-like portion of the tip edge striker 46. When the sliding doors 22A, 22B are closed, the hook of the tip edge lock unit 48 engages with the corresponding tip edge striker 46. The sliding doors 22A, 22B are thus fixed to each other. The positions of the tip edge striker 46 and the tip edge lock unit 48 may be opposite from those described above. That is, the tip edge striker 46 may be placed on the sliding door 22B, and the tip edge lock unit 48 may be placed on the sliding door 22A.

Lower edge strikers 50A, 50B are placed in the middle portion of the lower edge 28b of the boarding opening 28. A lower edge lock unit 52A corresponding to the lower edge striker 50A is placed at the corner formed by the tip edge 22Ac and lower edge 22Ab of the sliding door 22A. A lower edge lock unit 52B corresponding to the lower edge striker 50B is placed at the corner formed by the tip edge 22Bc and lower edge 22Bb of the sliding door 22B. Each of the lower edge lock units 52A, 52B includes a hook (not shown) that catches a rod-shaped portion of the corresponding lower edge striker 50A, 50B. When the sliding doors 22A, 22B are closed, the hooks of the lower edge lock units 52A, 52B engage with the corresponding lower edge strikers 50A, 50B. The sliding doors 22A, 22B are thus fixed to the vehicle body 12 at the lower edges 22Ab, 22Bb. The lower edge striker 50A and the lower edge lock unit 52A form a lower edge lock mechanism that fixes the lower end of the tip edge 22Ac of the sliding door 22A to the vehicle body side structure 26. The lower edge striker 50B and the lower edge lock unit 52B also form a lower edge lock mechanism that fixes the lower end of the tip edge 22Bc of the sliding door 22B to the vehicle body side structure 26.

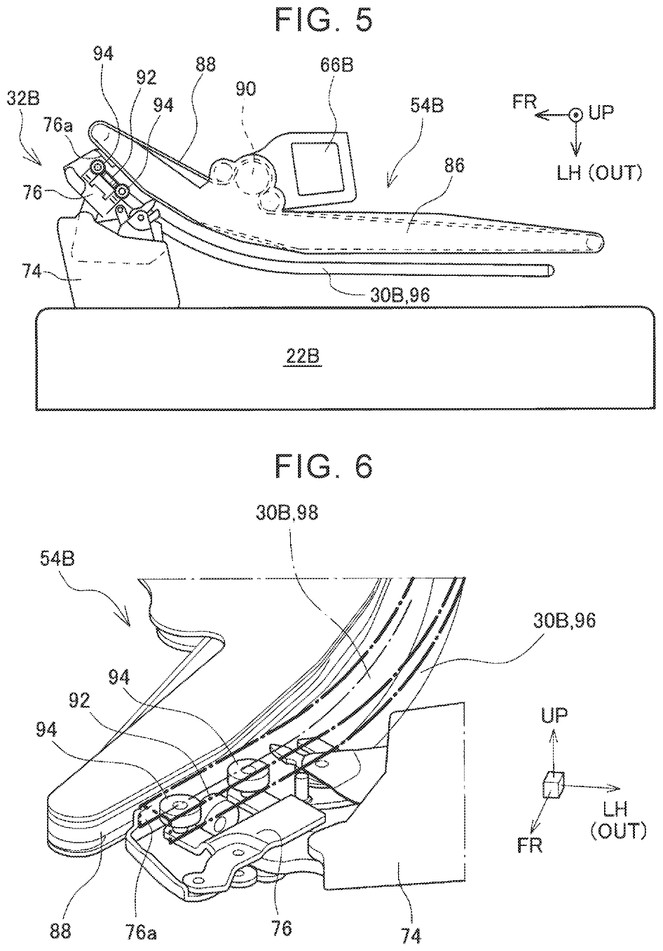

Drive units 54A, 54B that drive the sliding doors 22A, 22B to slide are mounted near the upper edge 28a of the boarding opening 28 on the vehicle body side structure 26. The drive units 54A, 54B are located inward of the upper support structures that support the sliding doors 22A, 22B in the lateral direction of the vehicle. Each of the drive units 54A, 54B includes a drive motor 66A, 66B and a transmission element such as a belt (see FIG. 5), particularly a toothed belt, that connects the drive motor 66A, 66B and the corresponding upper hinge 32A, 32B. The drive motors 66A, 66B cause the upper hinges 32A, 32B to slide along the upper rails 30A, 30B. The sliding doors 22A, 22B thus slide to open and close.

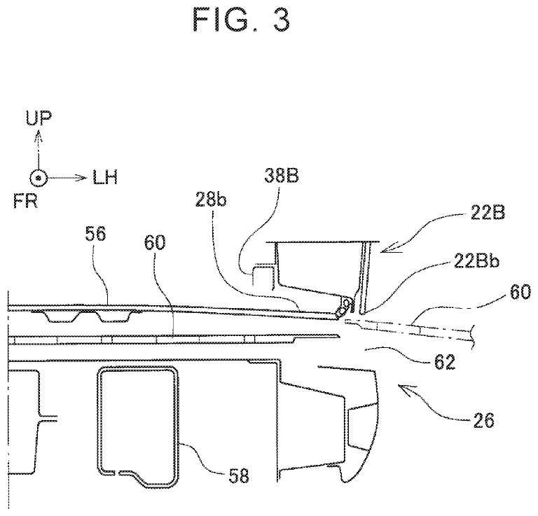

FIG. 3 shows, in section perpendicular to the longitudinal direction of the vehicle 10, the vehicle body side structure 26 and the sliding door 22B around the lower edge 28b of the boarding opening 28. A section of the sliding door 22A also appears similarly. The lower edge 28b of the boarding opening 28 is a part of the left side edge of a floor 56, and the floor 56 is substantially flush with the lower edge 28b of the boarding opening 28. A ramp 60 is stored between the floor 56 corresponding to the boarding opening 28 and an underframe 58 of the vehicle body 12. The ramp 60 is deployed in the lateral direction of the vehicle 10 through a ramp opening 62 as necessary when, for example, an occupant on a wheelchair gets into and out of the vehicle 10 (the ramp 60 deployed in the lateral direction of the vehicle 10 is shown by a long dashed short dashed line in FIG. 3). The ramp opening 62 is adjacent to the lower edge 28b of the boarding opening 28 of the vehicle body side structure 26. Deployment and retraction of the ramp 60 can be implemented by a drive device including a drive motor.

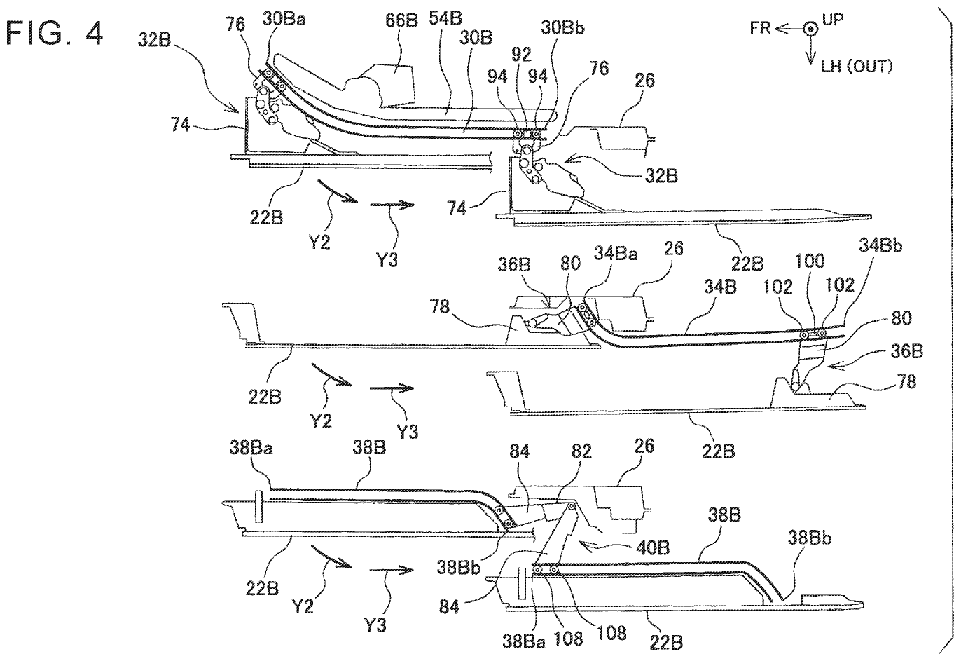

FIG. 4 shows how the sliding door 22B slides, and shows the closed and open states of the sliding door 22B in an overlapping manner. The upper part of FIG. 4 shows a support structure related to the upper rail 30B, the middle part of FIG. 4 shows a support structure related to the center rail 34B, and the lower part of FIG. 4 shows a support structure related to the lower rail 38B. The configuration related to the sliding door 22A appears symmetrically with the configuration related to the sliding door 22B in FIG. 4.

Each of the rails 30B, 34B, and 38B extends in the longitudinal direction of the vehicle 10. The end of each rail 30B, 34B, 38B located closer to the other sliding door 22A is referred to as “tip end,” and the end of each rail 30B, 34B, 38B located farther away from the other sliding door 22A is referred to as “base end.” In FIG. 4, the left end (that is, the front end in the longitudinal direction of the vehicle 10) of each rail 30B, 34B, 38B is the tip end, and the right end (that is, the rear end in the longitudinal direction of the vehicle 10) of each rail 30B, 34B, 38B is the base end.

The upper rail 30B is curved inward in the lateral direction of the vehicle 10 toward its tip end 30Ba. The upper rail 30B has a substantially straight shape on the base end 30Bb side of the curved portion. The upper hinge 32B includes an upper hinge base 74 fixed to the sliding door 22B, and an upper hinge bracket 76 that is rotatable with respect to the upper hinge base 74. The upper hinge bracket 76 rotatably supports rollers 92, 94 at its tip end. The rollers 92, 94 engage with the upper rail 30B (see FIGS. 5 to 7).

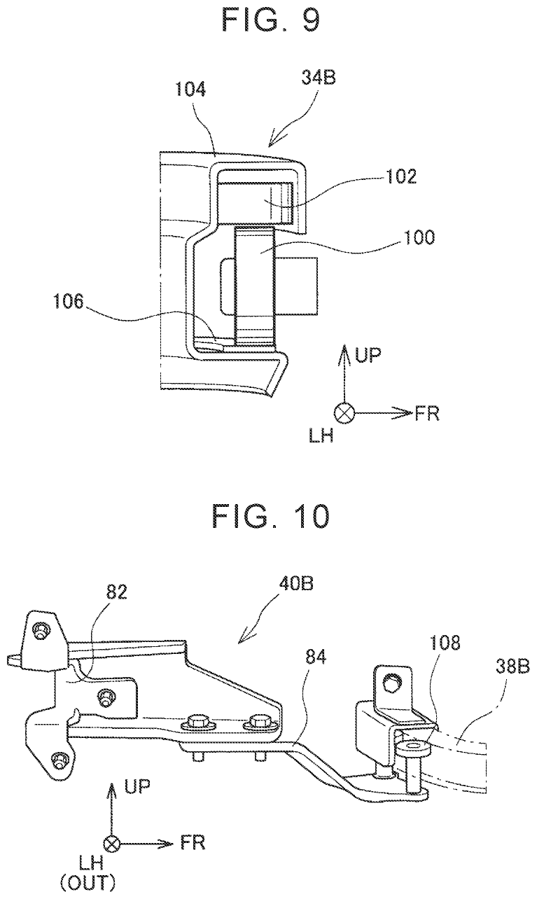

The center rail 34B is curved inward in the lateral direction of the vehicle 10 toward its tip end 34Ba. The center rail 34B has a substantially straight shape on the base end 34Bb side of the curved portion. The center rail 34B may be slightly curved inward in the lateral direction of the vehicle toward the base end 34Bb. The base edge 22Bd of the sliding door 22B is thus located closer to the vehicle body 12 when the sliding door 22B is opened. The center hinge 36B includes a center hinge base 78 fixed to the sliding door 22B, and a center hinge bracket 80 that is rotatable with respect to the center hinge base 78. The center hinge bracket 80 rotatably supports rollers 100, 102 at its tip end. The rollers 100, 102 engage with the center rail 34B (see FIGS. 8 and 9).

The lower rail 38B is curved outward in the lateral direction of the vehicle 10 toward its base end 38Bb. The lower rail 38B has a substantially straight shape on the tip end 38Ba side of the curved portion. The lower hinge 40B includes a lower hinge base 82 fixed to the vehicle body side structure 26, and a lower hinge bracket 84 that is rotatable with respect to the lower hinge base 82. The lower hinge bracket 84 rotatably supports rollers 108 at its tip end. The rollers 108 engage with the lower rail 38B (see FIG. 10).

When the sliding door 22B opens from the closed state shown on the left side (that is, on the front side in the longitudinal direction of the vehicle 10) in FIG. 4, the sliding door 22B is first guided by the curved portions of the rails 30B, 34B, and 38B to move rearward while moving outward in the lateral direction of the vehicle 10, as shown by arrows Y2. As a result, the sliding door 22B protrudes outward in the lateral direction of the vehicle 10 from the vehicle body side structure 26. Subsequently, the sliding door 22B slides outside the vehicle body side structure 26 rearward along the surface of the vehicle body side structure 26 as shown by arrows Y3. The sliding door 22B is thus moved to the open state shown on the right side (that is, on the rear side in the longitudinal direction of the vehicle 10) in FIG. 4.

When the sliding door 22B closes, the sliding door 22B is operated in the opposite manner to that described above. When the sliding door 22B moves to the closed position, the base edge lock unit 44B, the tip edge lock unit 48, and the lower edge lock unit 52B operate to lock the sliding door 22B at the closed position.

The opening and closing operation of the other sliding door 22A is the same as that of the sliding door 22B described above except for the sliding direction. The sliding direction of the other sliding door 22A is opposite to the sliding direction of the sliding door 22B.

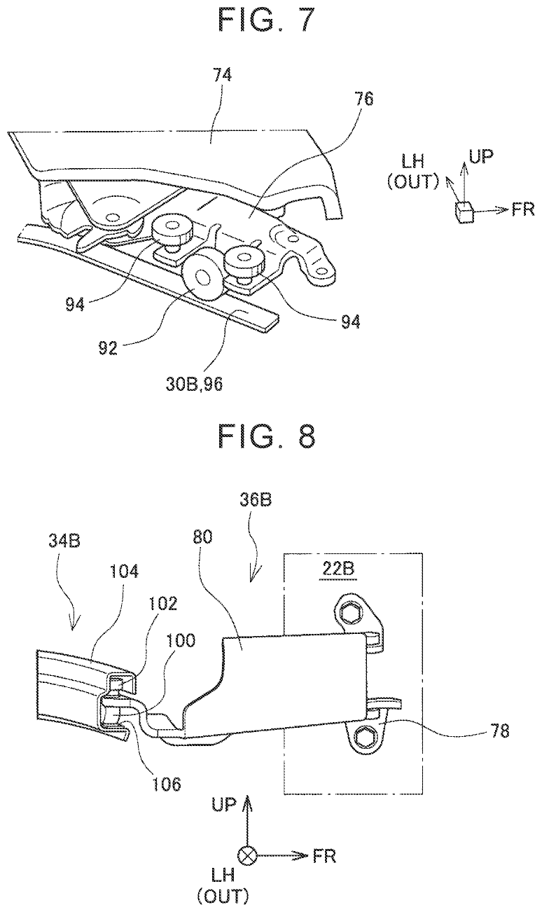

FIGS. 5 to 7 show details of the drive unit 54B and the upper support structure. FIG. 7 shows the upper hinge bracket 76 and the structure around the upper hinge bracket 76 as viewed from the inner side in the lateral direction of the vehicle 10. The drive unit 54B includes a drive unit body 86 extending parallel to the upper rail 30B, and a drive motor 66B fixed to the drive unit body 86. The drive unit 54B further includes a drive belt 88 wound around two pulleys located at both ends of the drive unit body 86. The drive belt 88 rotates as driven by the drive motor 66B via a drive pulley 90. The drive belt 88 and the drive pulley 90 may be a toothed belt and a toothed pulley, respectively. A belt coupling portion 76a of the upper hinge bracket 76 is coupled to the drive belt 88, and the upper hinge bracket 76 moves along the upper rail 30B with the rotation of the drive belt 88. The sliding door 22B slides with the movement of the upper hinge bracket 76. The drive belt 88 is disposed along the upper rail 30B. Specifically, the drive belt 88 extends along about the same length as the upper rail 30B so that the upper hinge bracket 76 can be moved along the entire length of the upper rail 30B. In order to dispose the drive belt 88 in this manner, the drive unit body 86 is also disposed along the upper rail 30B. The drive unit 54B is thus placed along the upper support structure for the sliding door 22B.

An upper main roller 92 that supports the weight of the sliding door 22B and upper guide rollers 94 that are guided in a horizontal plane are rotatably provided on the upper hinge bracket 76. In this example, there are one upper main roller 92 and two upper guide rollers 94. The upper main roller 92 is disposed such that its rotation axis is horizontal, and the upper guide rollers 94 are disposed such that their rotation axes are vertical. The upper rail 30B includes a support rail portion 96 and an upper guide rail portion 98. The upper main roller 92 rolls on the upper surface of the support rail portion 96 as the upper hinge bracket 76 moves. The upper guide rail portion 98 guides the upper guide rollers 94. The upper guide rail portion 98 is shown by long dashed short dashed lines in FIG. 6. The upper guide rail portion 98 has a U-shaped section that opens downward. The upper guide rollers 94 are located inside the U-shape, and the upper guide rail portion 98 guides the upper guide rollers 94 in a horizontal plane.

FIGS. 8 and 9 show details of the middle support structure as viewed from the inner side in the lateral direction of the vehicle 10. A center main roller 100 that supports the weight of the sliding door 22B and center guide rollers 102 that are guided in a horizontal plane are rotatably provided on the center hinge bracket 80. In this example, there are one center main roller 100 and two center guide rollers 102 sandwiching the center main roller 100 therebetween (see FIG. 4). The center main roller 100 is disposed such that its rotation axis is horizontal, and the center guide rollers 102 are disposed such that their rotation axes are vertical. The center rail 34B includes a support rail portion 106 and a center guide rail portion 104. The center main roller 100 rolls on the upper surface of the support rail portion 106 as the center hinge bracket 80 moves. The center guide rail portion 104 guides the center guide rollers 102. The center guide rail portion 104 has a U-shaped section that opens downward. The center guide rollers 102 are located inside the U-shape, and the center guide rail portion 104 guides the center guide rollers 102 in a horizontal plane.

FIG. 10 shows details of the lower support structure as viewed from the inner side in the lateral direction of the vehicle 10. Lower guide rollers 108 that are guided in a horizontal plane is rotatably provided on the lower hinge bracket 84. In this example, there are two lower guide rollers 108. The lower rail 38B guides the lower guide rollers 108 as the lower hinge bracket 84 moves. The lower support structure does not include a roller corresponding to the upper main roller 92 of the upper support structure and the center main roller 100 of the middle support structure. The lower rail 38B has a U-shaped section that opens downward. The lower guide rollers 108 are located inside the U-shape, and the lower rail 38B guides the lower guide rollers 108 in a horizontal plane.

The upper, middle, and lower support structures and drive unit 54A for the sliding door 22A are formed symmetrically with the upper, middle, and lower support structures and drive unit 54B for the sliding door 22B described above.

The weight of each sliding door 22A, 22B is supported by the upper and middle support structures, but not by the lower support structure. Therefore, the lower support structure need not include a roller and guide for supporting the weight, and the configuration is simplified. This contributes to lowering the floor of the vehicle when the lower rails are provided on the vehicle body side structure 26 instead of on the sliding doors.

The weight of each sliding door 22A, 22B may be supported by either the upper support structure or the middle support structure. By supporting the weight of each sliding door 22A, 22B by the upper support structure, the point of action of the input from each drive unit 54A, 54B and the point of action of the sliding resistance become closer to each other, and the moment that acts on the sliding doors 22A, 22B is reduced. This contributes to smooth sliding of the sliding doors 22A, 22B.

What is claimed is:

1. A vehicle side structure, comprising:
a vehicle body side structure including a boarding opening through which an occupant gets into and out of a vehicle;
a sliding door configured to slide to open and close the boarding opening;
an upper support structure configured to support the sliding door in an upper portion of the vehicle body side structure in a vertical direction of the vehicle such that the sliding door slides;
a middle support structure configured to support the sliding door in a middle portion of the vehicle body side structure in the vertical direction of the vehicle such that the sliding door slides;
a lower support structure configured to support the sliding door in a lower portion of the vehicle body side structure in the vertical direction of the vehicle such that the sliding door slides; and
a drive unit located in the upper portion of the vehicle body side structure and configured to drive the sliding door to open and close via at least a part of the upper support structure.

2. The vehicle side structure according to claim 1, wherein the upper support structure is located above an upper edge of the boarding opening in the vertical direction of the vehicle, and the drive unit is located inward of the upper support structure in a lateral direction of the vehicle along the upper support structure.

3. The vehicle side structure according to claim 1, wherein the sliding door is configured to be supported in the vertical direction of the vehicle by at least one of the upper support structure or the middle support structure.

4. The vehicle side structure according to claim 2, wherein
the upper support structure includes an upper rail and an upper hinge, the upper rail being located on the vehicle body side structure along the upper edge of the boarding opening, and the upper hinge being configured to slide with the sliding door and be guided by the upper rail,
the middle support structure includes a center rail and a center hinge, the center rail being located on the vehicle body side structure and extending from a side edge of the boarding opening in a direction away from the boarding opening, and the center hinge being configured to slide with the sliding door and be guided by the center rail,
the lower support structure includes a lower rail and a lower hinge, the lower rail being located on the sliding door at a position lower than the center hinge in the vertical direction of the vehicle and extending in a direction along a lower edge of the sliding door in the vertical direction of the vehicle, and the lower hinge being located on the vehicle body side structure near the side edge of the boarding opening and configured to guide the lower rail when the sliding door slides, and
the drive unit is configured to drive the upper hinge along the upper rail to drive the sliding door to open and close.

5. The vehicle side structure according to claim 4, wherein
the drive unit includes a belt extending along the upper rail, and a motor configured to drive the belt, and
the upper hinge includes a coupling portion configured to be coupled to the belt.

6. The vehicle side structure according to claim 4, wherein
the upper rail includes an upper guide rail portion that includes a pair of upper vertical walls extending in the vertical direction of the vehicle,
the upper hinge includes an upper guide roller located in such a manner that a rotation axis of the upper guide roller matches the vertical direction of the vehicle,
the upper guide roller is located between the upper vertical walls,
the center rail includes a center guide rail portion that includes a pair of center vertical walls extending in the vertical direction of the vehicle,
the center hinge includes a center guide roller located in such a manner that a rotation axis of the center guide roller matches the vertical direction of the vehicle,
the center guide roller is located between the center vertical walls,
the lower rail includes a lower guide rail portion that includes a pair of lower vertical walls extending in the vertical direction of the vehicle,
the lower hinge includes a lower guide roller located in such a manner that a rotation axis of the lower guide roller matches the vertical direction of the vehicle, and
the lower guide roller is located between the lower vertical walls.

7. The vehicle side structure according to claim 4, wherein
the upper rail includes an upper support rail portion, and
the upper hinge includes an upper support roller located on an upper surface of the upper support rail portion such that a rotation axis of the upper support roller is horizontal.

8. The vehicle side structure according to claim 4, wherein
the center rail includes a center support rail portion, and
the center hinge includes a center support roller located on an upper surface of the center support rail portion such that a rotation axis of the center support roller is horizontal.

9. The vehicle side structure according to claim 1, wherein the vehicle body side structure further includes a ramp opening located below a lower edge of the boarding opening in the vertical direction of the vehicle, and configured to allow a wheelchair ramp to pass through the ramp opening when the wheelchair ramp stored under a floor of the vehicle is deployed and retracted.

10. The vehicle side structure according to claim 1, wherein the sliding door includes a first sliding door and a second sliding door, and the sliding door is a double door provided by the first sliding door and the second sliding door.
